(19) United States
(12) Patent Application Publication
(10) Pub. No.: US 2026/0159431 A1
(43) Pub. Date: Jun. 11, 2026

(54) METHOD FOR PRODUCING GLASS ARTICLE

(71) Applicant: AGC Inc., Tokyo (JP)

(72) Inventors: Yuki KUSHIOKA, Tokyo (JP); Takashi MUKAI, Tokyo (JP); Yuichi ORIHARA, Tokyo (JP); Terutaka MAEHARA, Tokyo (JP); Takashi ENOMOTO, Tokyo (JP); Riki HOSHINO, Tokyo (JP); Toshiaki MATSUYAMA, Tokyo (JP); Motoyuki HIROSE, Tokyo (JP); Kenichi MASUDA, Tokyo (JP)

(73) Assignee: AGC Inc., Tokyo (JP)

(21) Appl. No.: 19/404,235

(22) Filed: Dec. 1, 2025

(30) Foreign Application Priority Data
Dec. 5, 2024 (JP) 2024-212420

(51) Int. Cl. C03B 5/173; C03C 3/091

(52) U.S. Cl. CPC C03B 5/173; C03C 3/091

(57) ABSTRACT

The present invention relates to a method for producing a glass article, containing melting a glass raw material containing silica sand A and silica sand B by using a cold-top melting method, in which a volume-based median diameter of the silica sand A is larger than that of the silica sand B, a content of the silica sand B with respect to a total content of the silica sand A and the silica sand B is adjusted in a range of 1 mass % to 99 mass %, and the silica sand A and the silica sand B satisfy the requirements 1 and 2 described in the specification.

### CROSS-REFERENCE TO RELATED APPLICATIONS

This application is based on and claims priority under 35 USC 119 from Japanese Patent Application No. 2024-212420 filed on Dec. 5, 2024, the contents of which are incorporated herein by reference.

### TECHNICAL FIELD

The present invention relates to a method for producing a glass article. More specifically, the present invention relates to a method for producing a glass article by using a cold-top melting method.

### BACKGROUND ART

Examples of a method of melting a glass raw material in producing a glass article include a method of heating the glass raw material in a melting tank with a burner or the like and a method of heating the glass raw material with Joule heat generated by energizing the glass raw material.

In this regard, a melting furnace for performing a method of melting a glass raw material by using only heat generated by energizing the glass raw material is also called a total electric melting furnace.

The total electric melting furnace is preferred in terms of high thermal efficiency and reduction in amount of energy during the production.

In addition, as the method of melting the glass raw material by using the total electric melting furnace, there is known a cold-top melting method in which the glass raw material is melted in a state where a liquid surface of a molten glass is covered with a solid glass raw material.

Examples of a method for producing a glass article by using the total electric melting furnace include a method using an electric melting furnace described in Patent Literature 1. Note that, paragraph 0030 in Patent Literature 1 discloses that when a glass article is to be produced by using the electric melting furnace described in Patent Literature 1, a cold-top type in which the entire molten glass is covered with a glass raw material may be used.
Patent Literature 1: JP 2018-080076A

### SUMMARY OF INVENTION

In the related-art cold-top melting method as described in Patent Literature 1, generally, the glass raw material is melted by heat from the molten glass melted by energization, and the glass raw material is charged from above the molten glass raw material so as to compensate for the molten glass raw material. In addition, the molten glass is discharged from the melting furnace at a predetermined speed, and is subjected to a subsequent fining step or the like.

In the cold-top melting method, a layer (hereinafter, also referred to as a “blanket”) made of the unmelted glass raw material is provided above the molten glass and can prevent heat dissipation from the molten glass, and the glass can be melted in a state of high thermal efficiency.

As described above, it can be said that the thickness of the blanket is an important control factor in the cold-top melting method. In general, it can be said that the thickness of the blanket is determined by a balance between a melting speed of the blanket and a charging speed of the glass raw material into the blanket. Therefore, it is understood that in order to control the thickness of the blanket to be constant, it is usually necessary to control the melting speed of the blanket and the charging speed of the glass raw material into the blanket to be balanced. Here, it can be said that the melting speed of the blanket is equal to a discharging speed of the molten glass in the case where the amount of the molten glass in the melting furnace is kept constant. In consideration of the above points, it can be said that, in order to control the thickness of the blanket to be constant, it is usually necessary to control the charging speed of the glass raw material and the discharging speed of the molten glass to be balanced.

That is, in the case where the thickness of the blanket is controlled to a predetermined thickness, it is usually necessary to control the charging speed of the glass raw material and the discharging speed of the molten glass to predetermined values. The charging speed of the glass raw material (that is, the discharging speed of the molten glass having the same value) when the thickness of the blanket is constant as described above is referred to as an “equilibrium raw material-charging speed” in the present specification. Here, the unit of the “equilibrium raw material-charging speed” in the present specification is “t/d/m²” which indicates the charging and flowing amount per unit area of melting of the glass raw material, and “d” means “day” (24 hours).

By the way, in the operation of the cold-top melting method, for example, in order to melt glasses having different compositions, control of a temperature of the molten glass in the melting furnace may be required.

The above requirement may be addressed by employing, for example, a method of increasing the amount of electricity to enhance the amount of heat generated, thereby raising the temperature of the molten glass. However, as the temperature of the molten glass rises, the thickness of the blanket decreases, the heat dissipation from the molten glass increases, and it becomes difficult to maintain the temperature of the molten glass. Therefore, it can be said that it is generally not easy to raise the temperature of the molten glass.

In addition, in the case where the amount of electricity is adjusted as described above, works such as tap-switching is often required. Further, since a large variation may be caused in kiln condition along with energization stop, a method of controlling the temperature of the molten glass by different means has been required.

On the other hand, in the operation of the cold-top melting method, control of the discharge amount of the molten glass may be required.

For example, it can be said that when the discharge amount of the molten glass is reduced simply in response to the above requirement, the thickness of the blanket is decreases, the heat dissipation from the molten glass increases, and it becomes difficult to maintain the temperature of the molten glass.

In addition, in the case where the amount of electricity is adjusted as described above, works such as tap-switching is often required, and further, since a large variation may be caused in kiln condition along with energization stop, a different method has been required.

In order to meet the above requirements, it can be said that it is necessary to control the thickness of the blanket simultaneously with at least one of the control of the temperature of the molten glass and the control of the discharge amount of the molten glass.

However, as described above, when the thickness of the blanket is controlled to a predetermined thickness, there is usually an equilibrium raw material-charging speed corresponding to the thickness. Therefore, it is generally difficult to control the discharge amount of the molten glass while controlling the thickness of the blanket at the same time. In addition, since the equilibrium raw material-charging speed varies depending on the temperature of the molten glass, it is generally difficult to control the temperature of the molten glass while controlling the thickness of the blanket at the same time.

In view of the above points, in the cold-top melting method, a method of controlling the equilibrium raw material-charging speed independently of the control of the thickness of the blanket has been required.

In addition, when the glass raw material is being melted by using the cold-top melting method, it is required that no unmelted glass raw material remains.

The present invention has been made in view of the above problems, and an object of the present invention is to provide a method for producing a glass article in which an equilibrium raw material-charging speed can be controlled and a glass raw material is less likely to remain unmelted in a cold-top melting method.

As a result of intensive studies on the above problems, the present inventors have found that the above equilibrium raw material-charging speed can be controlled by using two types of silica sand satisfying predetermined requirements as silica sand used as a glass raw material and adjusting a mixing ratio thereof. In addition, it has been found that no unmelted glass raw material remains by satisfying a predetermined requirement for the silica sand.

That is, the present inventors have found that the above problems can be solved by the following configurations.
(1) A method for producing a glass article, containing:
   melting a glass raw material containing silica sand A and silica sand B by using a cold-top melting method, in which
   a volume-based median diameter of the silica sand A is larger than a volume-based median diameter of the silica sand B,
   a content of the silica sand B with respect to a total content of the silica sand A and the silica sand B is adjusted in a range of 1 mass % to 99 mass %, and
   the silica sand A and the silica sand B satisfy the following requirement 1 and requirement 2:
   requirement 1: both the volume-based median diameter of the silica sand A and the volume-based median diameter of the silica sand B are 300 μm or less, and
   requirement 2: a value obtained by subtracting the volume-based median diameter of the silica sand B from the volume-based median diameter of the silica sand A is 35 μm or more.
(2) The method for producing a glass article according to the above (1), in which the content of the silica sand B with respect to the total content of the silica sand A and the silica sand B is adjusted in a range of 5 mass % to 95 mass %.
(3) The method for producing a glass article according to the above (1) or (2), in which the content of the silica sand B with respect to the total content of the silica sand A and the silica sand B is adjusted in a range of 10 mass % to 90 mass %.
(4) The method for producing a glass article according to any one of the above (1) to (3), further satisfying the following requirement 1-1:
   requirement 1-1: the volume-based median diameter of the silica sand A is 100 μm to 300 μm, and the volume-based median diameter of the silica sand B is 20 μm to 150 μm.
(5) The method for producing a glass article according to any one of the above (1) to (4), 5 further satisfying the following requirement 2-1:
   requirement 2-1: the value obtained by subtracting the volume-based median diameter of the silica sand B from the volume-based median diameter of the silica sand A is 50 μm or more.
(6) The method for producing a glass article according to any one of the above (1) to (5), further satisfying the following requirement 2-2:
   requirement 2-2: the value obtained by subtracting the volume-based median diameter of the silica sand B from the volume-based median diameter of the silica sand A is 60 μm or more.
(7) The method for producing a glass article according to any one of the above (1) to (6), further satisfying the following requirement 2-3:
   requirement 2-3: the value obtained by subtracting the volume-based median diameter of the silica sand B from the volume-based median diameter of the silica sand A is 200 μm or less.
(8) The method for producing a glass article according to any one of the above (1) to (7), wherein the total content of the silica sand A and the silica sand B with respect to a batch raw material in the glass raw material is 30 mass % to 90 mass %.

According to the present invention, it is possible to provide a method for producing a glass article in which an equilibrium raw material-charging speed can be controlled and a glass raw material is less likely to remain unmelted in a cold-top melting method.

### BRIEF DESCRIPTION OF DRAWINGS

FIG. 1 is a schematic cross-sectional view of a glass-melting apparatus for use in a cold-top melting method.

FIG. 2 is a schematic cross-sectional view of a melting furnace for measuring the equilibrium raw material-charging speed.

FIG. 3 is a graph showing a relationship between the amount of silica sand remaining in the glass raw material-melting speed test and a value of the equilibrium raw material-charging speed measured by an actual machine.

### DESCRIPTION OF EMBODIMENTS

Hereinafter, embodiments of the present invention will be described in detail. Constituent elements described below may be described based on representative embodiments of the present invention, but the present invention is not limited to such embodiments.

The terms used in the present specification have the following meanings.

A numerical range represented by using “to” means a range including numerical values described before and after “to” as a lower limit value and an upper limit value.

“ppm” is an abbreviation of parts-per-million and means 1/1,000,000 (10⁻⁶).

In the present specification, “silica sand” refers to a powder mainly containing silicon dioxide (silica, SiO₂). The content of silicon dioxide in the silica sand is generally 95 mass % or more, preferably 98 mass % or more, and more preferably 99 mass % or more, with respect to the total mass of the silica sand. The silica sand may be consist of silicon dioxide. That is, the content of silicon dioxide in the silica sand may be 100 mass %.

### <Method for Producing Glass Article>

In a method for producing a glass article according to the present invention, a glass raw material containing silica sand A and silica sand B to be described later is melted by using a cold-top melting method.

First, the cold-top melting method will be described with reference to the drawings.

### [Cold-Top Melting Method]

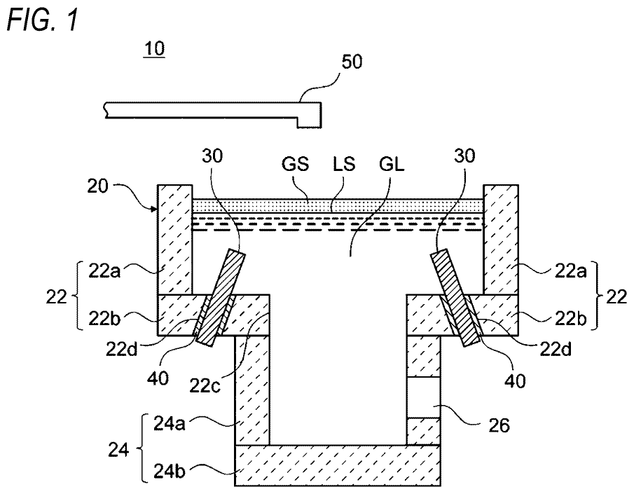

FIG. 1 is a schematic cross-sectional view of a glass-melting apparatus 10 for use in a cold-top melting method.

The glass-melting apparatus 10 melts a glass raw material GS supplied from a raw material supply unit 50 to obtain a molten glass GL. The glass raw material GS is usually prepared by mixing a plurality of types of materials. The glass raw material GS contains silica sand A and silica sand B to be described later.

The glass raw material GS will be described in detail later.

The glass-melting apparatus 10 includes a melting tank 20 that stores the glass raw material GS and the molten glass GL obtained by melting the glass raw material GS, and a plurality of electrodes 30 that electrically heat the molten glass GL.

The glass raw material GS is charged from the raw material supply unit 50 to a liquid surface LS of the molten glass GL, and forms a blanket made of the glass raw material GS on the liquid surface LS.

The layer (blanket) made of the glass raw material GS is gradually melted by heat transferred from the molten glass GL.

In order to prevent dissipation of heat or an evaporation component from the molten glass GL, the layer (blanket) made of the glass raw material GS preferably covers 80% or more of the liquid surface LS, and more preferably covers 90% or more of the liquid surface LS of the molten glass GL.

The maximum temperature of the surface of the layer (blanket) made of the glass raw material GS is preferably 500° C. or lower, more preferably 350° C. or lower, and still more preferably 200° C. or lower.

The glass-melting apparatus 10 is preferably a total electric melting furnace that melts the glass raw material GS only by electrically heating the molten glass GL. The total electric melting furnace includes only the plurality of electrodes 30 as a heating source for melting the glass raw material GS.

Note that, the glass-melting apparatus 10 may be an embodiment other than the total electric melting furnace, and the glass raw material GS may be melted by using energization heating of the molten glass GL and combustion heat of a combustible gas, heavy oil, or the like in combination. However, the ratio of the amount of heat by the energization heating to the amount of heat per unit time for melting the glass raw material GS is preferably 80% or more. Note that, in the total electric melting furnace, the ratio is 100%.

The melting tank 20 in the glass-melting apparatus 10 illustrated in FIG. 1 has a two-story structure (shelf structure), and includes a first tank 22 and a second tank 24 disposed below the first tank 22.

The first tank 22 has a first side wall 22a surrounding the molten glass GL, a first bottom wall 22b supporting the molten glass GL from below, and a flow port 22c formed through the first bottom wall 22b. The molten glass GL moves from the first tank 22 to the second tank 24 through the flow port 22c.

Note that, as the area of the liquid surface LS of the molten glass GL increases, the amount of the glass raw material GS charged per unit time can be increased, whereby the production amount of the molten glass GL can be increased.

The second tank 24 has a second side wall 24a extending downward from a peripheral edge portion of the flow port 22c and a second bottom wall 24b supporting the molten glass GL from below. The second side wall 24a is provided with an outlet 26.

The outlet 26 for the molten glass GL may be provided in the second bottom wall 24b.

Note that, the melting tank 20 may not have a shelf structure. That is, the melting tank 20 sufficiently include the first tank 22 and may not include the second tank 24. Note that, in the case where the melting tank 20 does not include the second tank 24, the flow port 22c is not formed in the first bottom wall 22b. In addition, in the case where the melting tank 20 does not include the second tank 24, the outlet 26 for the molten glass GL may be provided in the first side wall 22a or may be provided in the first bottom wall 22b.

The melting tank 20 is composed of, for example, a refractory brick. Examples of the refractory brick include an electroformed zirconia-based brick, an electroformed alumina-based brick, an electroformed alumina-zirconia-based brick, an electroformed alumina-zirconia-silica (AZS)-based brick, and a dense fired brick.

The melting tank 20 may include a plurality of types of refractory bricks.

In the embodiment illustrated in FIG. 1, the electrode 30 has a rod shape and protrudes obliquely upward from the first bottom wall 22b.

The electrode 30 is not particularly limited, and examples thereof include a molybdenum electrode.

Note that, an insertion hole 22d for inserting the electrode 30 is formed in the first bottom wall 22b. In addition, an electrode holder 40 is provided in the insertion hole 22d. The electrode holder 40 holds the electrode 30 and cools the electrode 30 to prevent the molten glass GL from leaking to the outside of the melting tank 20 through the insertion hole 22d. The electrode holder 40 is cooled by supplying a coolant such as water. Note that, the electrode holder 40 may hold a lower end of the electrode 30. In addition, in the embodiment illustrated in FIG. 1, the electrode holder 40 does not protrude upward from the insertion hole 22d, but may protrude therefrom.

Note that, in the present invention, it is needless to say that the glass-melting apparatus 10 other than that illustrated in FIG. 1 may be used.

### [Glass Raw Material]

In the present invention, the glass raw material to be melted by using the cold-top melting method contains silica sand A and silica sand B.

Here, the volume-based median diameter of the silica sand A is larger than the volume-based median diameter of the silica sand B. In addition, the content of the silica sand B with respect to the total content of the silica sand A and the silica sand B is adjusted in a range of 1 mass % to 99 mass %.

Further, the silica sand A and the silica sand B satisfy the following requirement 1 and requirement 2.

Requirement 1: both the volume-based median diameter of the silica sand A and the volume-based median diameter of the silica sand B are 300 μm or less.

Requirement 2: a value obtained by subtracting the volume-based median diameter of the silica sand B from the volume-based median diameter of the silica sand A is 35 μm or more.

That is, when the volume-based median diameter of the silica sand A is defined as D_{50A} (unit: μm) and the volume-based median diameter of the silica sand B is defined as D_{50B} (unit: μm), the D_{50A} and the D_{50B} satisfy the following relational expressions (1), (2), and (3).

$${D}_{50 A} > {D}_{50 B} \qquad ( 1 )$$

$${D}_{50 A} \leq 300 and {D}_{50 B} \leq 300 \qquad ( 2 )$$

$${D}_{50 A} - {D}_{50 B} \geq 35 \qquad ( 3 )$$

In the method for producing a glass article according to the present invention, in the cold-top melting method, the equilibrium raw material-charging speed can be controlled and the glass raw material is less likely to remain unmelted. The mechanism thereof is not exactly clear, but the present inventors have presumed as follows.

In the method for producing a glass article according to the present invention, the glass raw material often contains silica sand (SiO₂) and other raw materials. In general, since the melting point of SiO₂ is often higher than that of the other raw materials, the other raw materials melt first through dehydration, decomposition, and the like to often generate a liquid phase containing the other raw materials as main components. It is considered that the process of melting SiO₂ in the molten glass proceeds through a melting step of melting SiO₂ in the generated liquid phase and a diffusion step of diffusing the molten SiO₂ in the molten glass in this order. It is considered that, in the process of melting SiO₂ in the molten glass, the time required for the diffusion step is longer than that for the melting step. That is, it is usually considered that, in the process of melting SiO₂ in the molten glass, a diffusion step of diffusing the molten SiO₂ in the molten glass is a rate-limiting step.

Here, in the case where two types of silica sand having different particle diameters (median diameters) are mixed and used as in the method for producing a glass article according to the present invention, it can be said that the melting of the silica sand with smaller particle diameter (the above silica sand B) preferentially proceeds. It is considered that when the silica sand with smaller particle diameter melts first, a large amount of molten material containing a large amount of SiO₂ generated by the melting of the silica sand with smaller particle diameter will surround the silica sand with larger particle diameter (the above silica sand A).

It can be said that when the SiO₂-rich molten material is present around the silica sand with larger particle diameter, the melting of the silica sand with larger particle diameter is limited by the diffusion step, and it takes more time to melt the silica sand. When it takes time to melt the silica sand, the melting speed of the blanket decreases, and as a result, the value of the equilibrium raw material-charging speed decreases.

In addition, it can be said that the amount of the SiO₂-rich molten material (that is, the thickness of the SiO₂ diffusion layer) can be adjusted based on the content of the silica sand with smaller particle diameter contained in the glass raw material.

From the above, it is considered that the melting speed of the blanket can be controlled by adjusting the difference in particle diameter and mixing ratio of the silica sand with larger particle diameter and the silica sand with smaller particle diameter, whereby the equilibrium raw material-charging speed can be controlled independently of the control of the thickness of the blanket.

On the other hand, in the case where the particle diameter of the silica sand is large, the time required for melting the silica sand tends to be long, which tends to cause the glass raw material to remain unmelted. In the method for producing a glass article according to the present invention, it is considered that in the case where the volume-based median diameter of the silica sand contained in the glass raw material is set to 300 μm or less, the glass raw material is less likely to remain unmelted.

The volume-based median diameters (the above D_{50A} and D_{50B}) of the silica sand A and the silica sand B are each a particle diameter at which a cumulative frequency in a particle size distribution is 50% in volume percentage when a particle size distribution curve is obtained by using a laser particle size distribution analyzer. Specifically, the particle size distribution curve is obtained by using a laser particle size distribution analyzer using the following apparatus and conditions.
Apparatus name: LA960S2 (manufactured by Horiba, Ltd.)
Dispersion medium: water
Measurement pretreatment: ultrasonic treatment (1 minute)

The volume-based median diameter D_{50A} (unit: μm) of the silica sand A is not particularly limited as long as the above requirements are satisfied, and is preferably 80 μm or more, more preferably 100 μm or more, and still more preferably 200 μm or more.

In addition, the D_{50A} is 300 μm or less, preferably 280 μm or less, and more preferably 250 μm or less. The D_{50A} may be 200 μm or less, or may be 100 μm or less.

The volume-based median diameter D_{50B} (unit: μm) of the silica sand B is not particularly limited as long as the above requirements are satisfied, and is preferably 10 μm or more, more preferably 20 μm or more, and still more preferably 30 μm or more. Note that, the D_{50B} may be 50 μm or more, or may be 100 μm or more.

In addition, the D_{50B} is 265 μm or less, preferably 200 μm or less, and more preferably 150 μm or less.

In addition, it is also preferable for the silica sand A and the silica sand B to further satisfy the following requirement 1-1.

Requirement 1-1: the volume-based median diameter of the silica sand A is 100 μm to 300 μm, and the volume-based median diameter of the silica sand B is 20 μm to 150 μm. Note that, the silica sand A and the silica sand B satisfy the above requirement 2. It is also preferable for the silica sand A and the silica sand B to further satisfy the [0037] following requirement 1-2.

Requirement 1-2: the volume-based median diameter of the silica sand A is 130 μm to 250 μm, and the volume-based median diameter of the silica sand B is 30 μm to 150 μm. Note that, the silica sand A and the silica sand B satisfy the above requirement 2.

In addition, it is also preferable for the silica sand A and the silica sand B to further satisfy the following requirement 2-1.

Requirement 2-1: the value obtained by subtracting the volume-based median diameter of the silica sand B from the volume-based median diameter of the silica sand A is 50 μm or more.

Note that, the silica sand A and the silica sand B satisfy the above requirement 1 and requirement 2.

In addition, it is also preferable for the silica sand A and the silica sand B to further satisfy the following requirement 2-2.

Requirement 2-2: the value obtained by subtracting the volume-based median diameter of the silica sand B from the volume-based median diameter of the silica sand A is 60 μm or more.

Note that, the silica sand A and the silica sand B satisfy the above requirement 1 and requirement 2.

In addition, it is also preferable for the silica sand A and the silica sand B to further satisfy the following requirement 2-3.

Requirement 2-3: the value obtained by subtracting the volume-based median diameter of the silica sand B from the volume-based median diameter of the silica sand A is 200 μm or less.

Note that, the silica sand A and the silica sand B satisfy the above requirement 1 and requirement 2.

In addition, it is also preferable for the silica sand A and the silica sand B to further satisfy the following requirement 2-4.

Requirement 2-4: the value obtained by subtracting the volume-based median diameter of the silica sand B from the volume-based median diameter of the silica sand A is 150 μm or less.

Note that, the silica sand A and the silica sand B satisfy the above requirement 1 and requirement 2.

The silica sand A and the silica sand B satisfy the above requirements, and the particle size distribution of the silica sand A and the silica sand B may be unimodal or multimodal, and is preferably unimodal.

As described above, the glass raw material contains the silica sand A and the silica sand B. Here, the total content of the silica sand A and the silica sand B with respect to the batch raw material in the glass raw material is preferably 20 mass % or more, more preferably 30 mass % or more, and still more preferably 40 mass % or more, from the viewpoint of more easily controlling the equilibrium raw material-charging speed.

In addition, the total content of the silica sand A and the silica sand B with respect to the batch raw material in the glass raw material is often 95 mass % or less, preferably 90 mass % or less, and more preferably 80 mass % or less.

Note that, the batch raw material in the glass raw material refers to the glass raw material excluding a cullet raw material to be described later, and the batch raw material is usually composed of the silica sand A, the silica sand B, and other raw materials to be described later.

The content of the batch raw material with respect to the glass raw material is usually 40 mass % or more, and is often 50 mass % or more. In addition, the content of the batch raw material with respect to the glass raw material may be 100 mass %, and is often 95 mass % or less.

Examples of the other raw materials other than the silica sand A and the silica sand B contained in the glass raw material include a compound containing elements to be contained in the glass composition to be described later.

The other raw materials are compounds of the elements to be contained in the glass composition to be described later, and raw materials in the form usually used as glass raw materials can be appropriately used.

Examples of the other raw materials include an oxide, a hydroxide, and a chloride of the elements to be contained in the glass composition to be described later, and a carbonate, a nitrate, and a sulfate containing the elements to be contained in the glass composition to be described later.

The volume-based median diameter of each of the other raw materials is preferably 5 μm or more, and more preferably 10 μm or more. In addition, the volume-based median diameter of each of the other raw materials is preferably 1,000 μm or less, and more preferably 500 μm or less.

The volume-based median diameters of the other raw materials can be measured by the same measurement method as the volume-based median diameters of the silica sand A and the silica sand B.

The glass raw material may contain the cullet raw material in addition to the batch raw material.

The cullet raw material refers to a raw material obtained by pulverizing a glass. The cullet raw material can be obtained by pulverizing, for example, glass scraps after obtaining a target glass article in another step to be described later, a non-standard glass article, and the like. The composition of the cullet raw material usually coincides with the composition of molten glass to be obtained by melting the glass raw material.

The content of the cullet raw material with respect to the glass raw material is often 5 mass % or more. In addition, the content of the cullet raw material with respect to the glass raw material is usually 60 mass % or less, and often 50 mass % or less. Note that, the glass raw material may not contain the cullet raw material.

The batch raw material may contain a silicon dioxide raw material other than the silica sand A and the silica sand B, but preferably does not contain a silicon dioxide raw material other than the silica sand A and the silica sand B.

In the case where the batch raw material contains a silicon dioxide raw material other than the silica sand A and the silica sand B (other silicon dioxide raw material), the volume-based median diameter of the other silicon dioxide raw material is preferably 2,300 μm or less.

In addition, in the method for producing a glass article according to the present invention, the content of the silica sand B with respect to the total content of the silica sand A and the silica sand B is adjusted in a range of 1 mass % to 99 mass %. Here, the content of the silica sand B with respect to the total content of the silica sand A and the silica sand B is preferably adjusted in a range of 5 mass % to 95 mass %, more preferably adjusted in a range of 10 mass % to 90 mass %, and still more preferably adjusted in a range of 15 mass % to 85 mass %, from the viewpoint of more easily controlling the equilibrium raw material-charging speed.

The content of the silica sand B with respect to the total content of the silica sand A and the silica sand B in the glass raw material can be adjusted by using a known method.

In the embodiment illustrated in FIG. 1 described above, the glass raw material GS supplied from the raw material supply unit 50 is, for example, supplied after mixing powders constituting the glass raw material GS each other. Here, when mixing the powders constituting the glass raw material GS, the content (ratio) of the silica sand B can be adjusted by adjusting the amounts of the silica sand A and the silica sand B used.

In addition, in the case of continuously supplying the glass raw materials GS, it is also preferable to provide a raw material-mixing unit (not illustrated) between the raw material supply unit 50 and a plurality of raw material storage units (not illustrated) that store the respective raw materials. Here, in the case of adjusting the content (ratio) of the silica sand B, it is sufficient to adjust the supply speed of the silica sand A supplied from the raw material storage unit storing the silica sand A to the raw material-mixing unit and the supply speed of the silica sand B supplied from the raw material storage unit storing the silica sand B to the raw material-mixing unit.

### [Glass Composition]

A preferred composition of the molten glass obtained by using the cold-top melting method in the method for producing a glass article according to the present invention will be described. That is, a preferred glass composition of a glass article obtained by the method for producing a glass article according to the present invention will be described.

The glass composition may be a composition containing an alkali component (for example, a soda glass, a soda lime glass, a borosilicate glass, and an aluminosilicate glass), or may be a composition substantially free of an alkali component (alkali-free glass).

The expression “substantially free of an alkali component” means that the total content of alkali metal oxides (Li₂O, Na₂O, and K₂O) is 1,000 ppm by mass or less.

Examples of the composition of the alkali-free glass include a composition containing, in mass % in terms of oxides, 54% to 73% of SiO₂, 10% to 23% of Al₂O₃, 0.1% to 12% of B₂O₃, 0% to 12% of MgO, 0% to 15% of CaO, 0% to 16% of SrO, 0% to 15% of BaO, and 8% to 26% of MgO, CaO, SrO, and BaO in total. Here, B₂O₃, MgO, CaO, SrO, and BaO are not essential components but optional components.

Examples of the other composition of the alkali-free glass include a composition containing, in mass % in terms of oxides, 57% to 67.5% of SiO₂, 17% to 25% of Al₂O₃, 0.1% to 5.5% of B₂O₃, 2% to 8.5% of MgO, 1.5% to 8.5% of CaO, 0.5% to 10% of SrO, and 0% to 2.5% of BaO.

In addition, examples of the other composition of the alkali-free glass include a composition containing, in mass % in terms of oxides, 45% to 75% of SiO₂, 1% to 15% of Al₂O₃, 1% to 30% of B₂O₃, 0.1% to 13% of MgO, 0.1% to 13% of CaO, 0.1% to 13% of SrO, and 0% to 13% of BaO.

### [Other Steps]

The method for producing a glass article according to the present invention may include steps other than the steps described above.

Examples of the other steps include a fining step of fining the molten glass, a forming step of forming the molten glass, and a processing step of processing the formed glass article.

That is, in the method for producing a glass article according to the present invention, the obtained molten glass may be fined and the fined molten glass may be formed to obtain a glass article.

The fining step, the forming step, and the processing step can be performed by using known methods.

### <Glass Article>

A glass article is obtained by the method for producing a glass article according to the present invention described above.

The application of the obtained glass article is not particularly limited, and the glass article can be appropriately applied to applications in which the glass article has been used in the related art.

### EXAMPLES

Hereinafter, the present invention will be described in more detail based on Examples. The materials, amounts used, ratios, treatment details, treatment procedures, and the like shown in the following Examples can be changed as appropriate without departing from the spirit of the present invention. Therefore, the scope of the present invention should not be construed as being limited to the following Examples.

### <Melting Speed Test for Glass Raw Material>

A glass raw material was prepared so as to have the following composition. Note that, the following composition is expressed in mass % in terms of oxides.

SiO₂: 60%, Al₂O₃: 17%, B₂O₃: 8%, MgO: 3%, CaO: 4%, SrO: 8%

Note that, as a raw material of SiO₂, silica sand 1 to silica sand 6 having a volume-based median diameter (D₅₀) of the following value were used.
Silica sand 1: D₅₀=37 μm
Silica sand 2: D₅₀=51 μm
Silica sand 3: D₅₀=125 μm
Silica sand 4: D₅₀=147 μm
Silica sand 5: D₅₀=214 μm
Silica sand 6: D₅₀=319 μm
Silica sand 7: D₅₀=273 μm

A glass raw material containing two types of silica sand selected from the silica sands 1 to 7 was uniformly mixed, housed in a crucible, and subjected to a heat treatment during which the glass raw material was heated to 1,550° C. and then taken out of a heating furnace without retention time. In the heat treatment, the temperature-rising speed was 10° C./min, and after taken out of the heating furnace, the resultant was cooled with water. The amount of the glass raw material was 15 g, and the heat treatment was performed under the atmosphere.

The content in the crucible was taken out after the heat treatment, and the amount of the silica sand remaining after the heat treatment was quantified by X-ray diffraction measurement. Note that, regarding the amount of the remaining silica sand, the amount of SiO₂ remaining after the heat treatment (the amount of the remaining silica sand) was determined based on an intensity ratio of SiO₂/ZnO to a mass ratio of SiO₂/ZnO prepared in advance. The results are shown in Table 1.

Note that, in Table 1, the column of “Content of silica sand A” represents the content of the silica sand A with respect to the total content of the silica sand A and the silica sand B.

In addition, in Table 1, the column of “Difference from linear interpolation” represents the value of the difference in the amount of the remaining silica sand in the case where the content of silica sand A is 50 mass %, compared to the linear interpolation calculated from the values in the cases where the content of silica sand A is 0 mass % and 100 mass %. It can be said that the larger the value in the column of “Difference from linear interpolation” is, the larger the amount of the remaining silica sand changes when the silica sand A and the silica sand B are mixed.

TABLE 1

| | | | | | | | Amount | |
|---|---|---|---|---|---|---|---|---|
| | | D_{50A} | | D_{50B} | | Content | [mass %] of | Difference |
| | | [μm] of | | [μm] of | D_{50A} − | [mass %] | silica sand | [mass %] |
| | Silica | silica | Silica | silica | D_{50B} | of silica | remaining after | from linear |
| | sand A | sand A | sand B | sand B | [μm] | sand A | heat treatment | interpolation |
| Ex. 1 | Silica | 214 | Silica | 51 | 163 | 0 | 0.53 | — |
| | sand 5 | | sand 2 | | | 50 | 4.76 | 2.79 |
| | | | | | | 100 | 3.40 | — |
| Ex. 2 | Silica | 51 | Silica | 37 | 14 | 0 | 2.52 | — |
| | sand 2 | | sand 1 | | | 50 | 1.60 | 0.08 |
| | | | | | | 100 | 0.53 | — |
| Ex. 3 | Silica | 214 | Silica | 37 | 177 | 0 | 2.52 | — |
| | sand 5 | | sand 1 | | | 50 | 4.75 | 1.79 |
| | | | | | | 100 | 3.40 | — |
| Ex. 4 | Silica | 319 | Silica | 147 | 172 | 0 | 4.30 | — |
| | sand 6 | | sand 4 | | | 50 | 7.60 | 1.90 |
| | | | | | | 100 | 7.10 | — |
| Ex. 5 | Silica | 214 | Silica | 147 | 67 | 0 | 4.30 | — |
| | sand 5 | | sand 4 | | | 50 | 5.37 | 1.52 |
| | | | | | | 100 | 3.40 | — |
| Ex. 6 | Silica | 147 | Silica | 125 | 22 | 0 | 3.25 | — |
| | sand 4 | | sand 3 | | | 50 | 3.92 | 0.14 |
| | | | | | | 100 | 4.30 | — |
| Ex. 7 | Silica | 273 | Silica | 52 | 222 | 50 | 6.90 | |
| | sand 7 | | sand 2 | | | | | |

As seen from the results shown in Table 1, in the case where two types of silica sand are mixed, the amount of the silica sand remaining after the heat treatment changes.

Here, when Examples 1, 3 and 5 satisfying the above requirement 2 are compared with Examples 2 and 6 not satisfying the above requirement 2, it can be seen that in Examples 1, 3 and 5 where two types of silica sand are mixed, the amount of the remaining silica sand more largely changes.

In addition, when Examples 1, 3 and 5 satisfying the above requirement 1 are compared with Example 4 not satisfying the above requirement 1, it can be seen that in Examples 1, 3 and 5, even when two types of silica sand are mixed, the amount of the remaining silica sand does not exceed a certain value (specifically, 6.90 mass %, which is the amount of the remaining silica sand of Example 7).

Hereinafter, a relationship between the amount of the silica sand remaining after the heat treatment and the equilibrium raw material-charging speed will be studied.

In addition, hereinafter, a relationship between the amount of the silica sand remaining after the heat treatment and the glass raw material remaining unmelted is studied, and the results are described below. That is, the relationship between the amount of the silica sand remaining after the heat treatment being more than 6.90 mass % and the glass raw material remaining unmelted is studied.

### <Measurement of Equilibrium Raw Material-Charging Speed>

Based on the above principle, the amount of the remaining silica sand in the melting speed test for the glass raw material is considered to have a relationship with the melting speed of the blanket. That is, it is considered that, in the above test, in the case where the amount of the remaining silica sand is large, the melting speed of the blanket can be controlled to be slower, and in the case where the amount of the remaining silica sand is small, the melting speed of the blanket can be controlled to be faster.

Here, the equilibrium raw material-charging speed when a predetermined silica sand was actually mixed and used as the glass raw material was measured by using an actual machine.

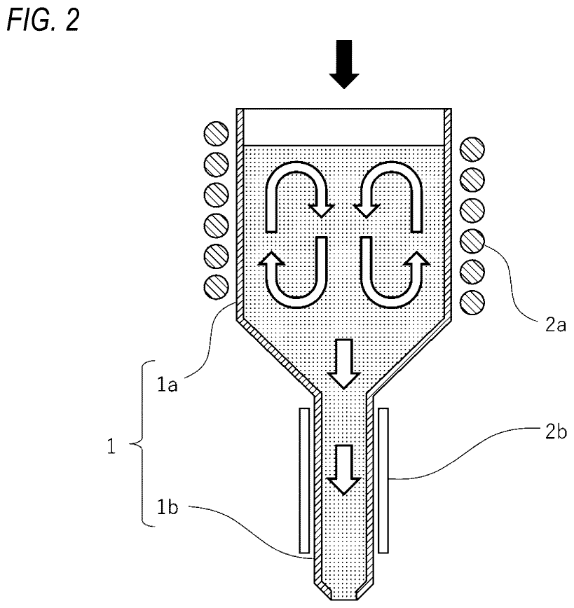

Specifically, the equilibrium raw material-charging speed was measured in a melting furnace illustrated in FIG. 2 by using a glass raw material obtained by mixing the silica sand and other raw materials.

The melting furnace illustrated in FIG. 2 includes a substantially funnel-shaped crucible 1. An upper opening of the crucible 1 is a glass raw material inlet. The molten glass is continuously obtained by supplying the glass raw material from the inlet while extracting the molten glass from the furnace bottom.

An induction heating device 2a is provided on an outer periphery of a melting unit 1a in an upper portion of the crucible 1, and an object to be heated in the crucible 1 can have a temperature gradient from a low-temperature region in an upper portion of the melting unit 1a to a high-temperature region in a lower portion of the melting unit 1a. An energization heating device 2b is provided in a drain out unit 1b at a lower portion of the crucible 1, and the extraction amount can be adjusted by adjusting the temperature of the glass flowing inside the drain out unit 1b.

In this example, the crucible 1 used was a platinum crucible in which the diameter of the melting unit 1a was 100 mm, the height of the melting unit 1a was 250 mm, and the length of the drain out unit 1b of 140 mm. Heating was performed such that the molten glass temperature (set temperature) in the melting unit 1a was 1,600° C. The position 200 mm below the upper end of the melting unit 1a was a position at which the temperature was controlled, and the temperature at this position was defined as the set temperature in the melting unit 1a.

In addition, the position 120 mm above the lower end of the drain out unit 1b was a position at which the temperature was controlled, and the temperature at this position was defined as the set temperature in the drain out unit 1b. The set temperature in the drain out unit 1b was controlled in a range of 1250° C. or higher and 1350° C. or lower.

The temperature of the drain out unit 1b of the crucible 1 was adjusted to adjust the extraction amount, and the glass raw material was continuously charged at a charging speed corresponding to the extraction amount. In a state where the charged amount and the extraction amount are balanced, a portion about 100 mm from the lower portion is filled with the molten glass and a portion about 140 mm from the upper portion is filled with the raw material in the melting unit 1a. The charging and flowing amount per unit area of melting of the glass raw material (t/d/m²) in this balanced state was measured and taken as the equilibrium raw material-charging speed.

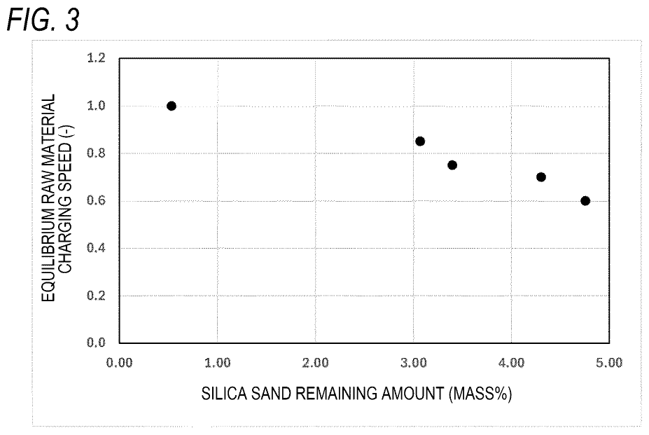

The measurement results of the equilibrium raw material-charging speed are shown in Table 2 and the graph in FIG. 3. In Table 2, the column of “Content of silica sand A” represents the content of the silica sand A with respect to the total content of the silica sand A and the silica sand B. In addition, in Table 2, the value of “equilibrium raw material-charging speed” is a value normalized by the value of the equilibrium raw material-charging speed in Example 8.

TABLE 2

| | | | Content | Amount [mass %] | Equilibrium raw |
|---|---|---|---|---|---|
| | | | [mass %] | of silica sand | material-charging |
| | | | of silica | remaining after | speed after |
| | Silica sand A | Silica sand B | sand A | heat treatment | normalization [—] |
| Ex. 8 | Silica sand 5 | Silica sand 2 | 0 | 0.53 | 1 |
| Ex. 9 | Silica sand 5 | Silica sand 2 | 25 | 3.07 | 0.85 |
| Ex. 10 | Silica sand 5 | Silica sand 2 | 50 | 4.76 | 0.6 |
| Ex. 11 | Silica sand 5 | Silica sand 2 | 100 | 3.40 | 0.75 |
| Ex. 12 | — | Silica sand 4 | 0 | 4.30 | 0.7 |

In the graph in FIG. 3, the horizontal axis represents the amount of the remaining silica sand in the melting speed test for the glass raw material, and the vertical axis represents the value of the equilibrium raw material-charging speed measured by using the actual machine. Note that, the value of the equilibrium raw material-charging speed shown on the vertical axis is a value normalized by the value of the equilibrium raw material-charging speed in Example 8.

As shown in FIG. 3, a strong negative correlation is observed between the amount of the remaining silica sand in the melting speed test for the glass raw material and the value of the equilibrium raw material-charging speed measured by using the actual machine. That is, it can be seen that when the amount of the remaining silica sand in the melting speed test for the glass raw material increases, the equilibrium raw material-charging speed is reduced.

Therefore, referring to Table 1 above and the results in Table 2 and FIG. 3, it can be seen that the equilibrium raw material-charging speed can be controlled in a wider range by mixing predetermined two types of silica sand.

That is, it can be seen that, when the glass raw material containing the silica sand A and the silica sand B is used and the glass raw material is melted by using the cold-top melting method, in the case where the volume-based median diameter of the silica sand A is larger than the volume-based median diameter of the silica sand B, the content of the silica sand B with respect to the total content of the silica sand A and the silica sand B is adjusted in a predetermined range, and the silica sand A and the silica sand B satisfy the above requirement 2, the equilibrium raw material-charging speed can be controlled.

Note that, in the above melting speed test for the glass raw material, when the above equilibrium raw material-charging speed was measured by using a glass raw material in which the amount of the remaining silica sand in the above heat treatment is more than 6.90 mass % (for example, the glass raw material in the case where the content of the silica sand A in Example 4 is 100 mass %), the glass raw material remaining unmelted was observed in the molten glass to be taken out. On the other hand, when the equilibrium raw material-charging speed was measured by using a glass raw material in which the amount of the remaining silica sand in the heat treatment is 6.90 mass % or less (for example, the glass raw material in the case where the content of the silica sand A in Example 6 is 100 mass %), no glass raw material remaining unmelted was observed in the molten glass to be taken out.

That is, it can be said that, in the case where at least one of the volume-based median diameter of the silica sand A and the volume-based median diameter of the silica sand B is more than 300 μm (that is, in the case where the requirement 1 is not satisfied), the glass raw material tends to remain unmelted.

On the other hand, it can be said that, in the case where the above requirement 1 is satisfied, the glass raw material is less likely to remain unmelted.

What is claimed is:

1. A method for producing a glass article, comprising:
melting a glass raw material containing silica sand A and silica sand B by using a cold-top melting method, wherein
a volume-based median diameter of the silica sand A is larger than a volume-based median diameter of the silica sand B,
a content of the silica sand B with respect to a total content of the silica sand A and the silica sand B is adjusted in a range of 1 mass % to 99 mass %, and
the silica sand A and the silica sand B satisfy the following requirement 1 and requirement 2:
requirement 1: both the volume-based median diameter of the silica sand A and the volume-based median diameter of the silica sand B are 300 μm or less, and
requirement 2: a value obtained by subtracting the volume-based median diameter of the silica sand B from the volume-based median diameter of the silica sand A is 35 μm or more.

2. The method for producing a glass article according to claim 1, wherein the content of the silica sand B with respect to the total content of the silica sand A and the silica sand B is adjusted in a range of 5 mass % to 95 mass %.

3. The method for producing a glass article according to claim 1, wherein the content of the silica sand B with respect to the total content of the silica sand A and the silica sand B is adjusted in a range of 10 mass % to 90 mass %.

4. The method for producing a glass article according to claim 1, further satisfying the following requirement 1-1:
requirement 1-1: the volume-based median diameter of the silica sand A is 100 μm to 300 μm, and the volume-based median diameter of the silica sand B is 20 μm to 150 μm.

5. The method for producing a glass article according to claim 1, further satisfying the following requirement 2-1:
requirement 2-1: the value obtained by subtracting the volume-based median diameter of the silica sand B from the volume-based median diameter of the silica sand A is 50 μm or more.

6. The method for producing a glass article according to claim 1, further satisfying the following requirement 2-2:
requirement 2-2: the value obtained by subtracting the volume-based median diameter of the silica sand B from the volume-based median diameter of the silica sand A is 60 μm or more.

7. The method for producing a glass article according to claim 1, further satisfying the following requirement 2-3:
requirement 2-3: the value obtained by subtracting the volume-based median diameter of the silica sand B from the volume-based median diameter of the silica sand A is 200 μm or less.

8. The method for producing a glass article according to claim 1, wherein the total content of the silica sand A and the silica sand B with respect to a batch raw material in the glass raw material is 30 mass % to 90 mass %.
